(19) United States
(12) Patent Application Publication
(10) Pub. No.: US 2007/0291670 A1
(43) Pub. Date: Dec. 20, 2007

(54) Method of Activating a Pdp Context

(76) Inventors: Mattias Pettersson, Lund (SE); Tony Larsson, Upplands Vasby (SE)

Correspondence Address: ERICSSON INC., 6300 LEGACY DRIVE, M/S EVR 1-C-11, PLANO, TX, 75024, US

(21) Appl. No.: 11/574,185

(22) PCT Filed: Aug. 26, 2004
(86) PCT No.: PCT/EP04/09635

§ 371 Date: Jul. 16, 2007

(51) Int. Cl. H04B 7/00

(52) U.S. Cl. 370/310

(57) ABSTRACT

The invention relates to a method of activating a PDP context via a mobile terminal (MT), such as a mobile telephone, initiated by a terminal equipment (TE), e.g. a laptop, where the terminal equipment (TE) is arranged to be connected to the mobile terminal (MT). Hitherto, such an activation of a PDP context via a mobile terminal, required the user of a terminal equipment to have quite specialized knowledge, e.g. a special reserved number defined by GPRS, an additional digit (the connection ID) for specifying a special APN to connect to, etc. The invention provides a user-friendly method of performing such an activation, in that the mobile terminal (MT) is arranged to listen for an activation trigger from the terminal equipment (TE) and to perform said activation upon the reception of an activation trigger The invention moreover relates to a mobile terminal.

### FIELD OF THE INVENTION

This invention relates to a method of activating a PDP context via a mobile terminal, initiated by a terminal equipment arranged to be connected to said mobile terminal, where said mobile terminal is arranged to be connected to a packet-based wireless communications network. The invention moreover relates to a mobile terminal arranged to be connected to a terminal equipment and arranged to be connected to a packet-based wireless communications network.

### BACKGROUND OF THE INVENTION

In data networks other than cellular networks the widespread standard to connect terminal equipment to the data network is by Ethernet technology. The usual mechanism used for configuration of an IP address and other parameters on the terminal equipment is Dynamic Host Configuration Protocol (DHCP). In a wireless network interconnected by Bluetooth, the Bluetooth Personal Area Network (PAN) profile and the Bluetooth Network Encapsulation Protocol (BNEP) will emulate Ethernet, so that the terminal equipment can use DHCP for configuration and can use IP for communication.

Connecting a terminal equipment, such as a laptop, a personal digital assistant (PDA), etc., to a Packet Data Network, such as the Internet, can be performed by the intermediate of a mobile terminal (MT), such as a mobile telephone, connecting to a packet-based wireless communications network, e.g GPRS (General Packet Radio Service) network.

Today, the connection between the terminal equipment and the mobile terminal is accomplished by the terminal equipment initiating a PPP (Point-to-Point Protocol) link to the mobile terminal. If Bluetooth is used between the terminal equipment and the mobile terminal, the dial-up profile is used to emulate a serial connection and PPP over that connection.

In the case where the packet-based wireless communications network, to which the mobile terminal is to be connected, is a GPRS (General Packet Radio Service) network, the terminal equipment may connect to different network points in a Packet Data Network (PDN), e.g. the Internet or a corporate network.

When the terminal equipment initiates a PPP link to the mobile terminal with the purpose of using the mobile terminal to connect to a cellular network, the mobile terminal must know what APN (Access Point Name) is intended and subsequently which PDP (Packet Data Protocol) context to activate. Today, this is indicated by the terminal equipment specifying a special reserved number relating to the context to activate, wherein one digit, viz. the Connection ID (CID), specifies, which predefined APN and corresponding PDP context for the mobile terminal to activate.

A backwards compatibility mode is known, wherein the terminal equipment can omit the CID, whereby the mobile terminal activates a default PDP context.

For a terminal equipment to connect to a PDN via a mobile terminal, it is therefore necessary that the terminal equipment supports PPP. Moreover, if the mobile terminal connects to e.g. an office LAN, the terminal equipment must also support the de-facto standard Ethernet and DHCP solution. The terminal equipment must furthermore be configured to specify the special reserved number defined by the packet-based wireless communications network. This is not general common knowledge amongst end-users.

Furthermore, if the above mentioned backwards-compatibility mode is not possible, the terminal equipment must include the CID corresponding to the APN to which the connection is desired. The knowledge of the CID can be obtained by reading data accounts listed in the mobile terminal. However, this requires many steps for the end-user and functions differently for different types of mobile terminals. Therefore, this concept typically becomes too difficult for the majority of end-users.

Finally, the terminal equipment must be able to receive user input in relation to which APN to activate. Unless the terminal equipment is pre-configured with a number specifying which APN to activate, where said number is synchronised with the APN list in the mobile terminal, the end-user must be involved in selecting an APN to activate. Thus, terminal equipment must be able to receive input from the end-user relating to said number. In the case where the terminal equipment is a device with very limited input and output capabilities, it may not be possible for an end-user to input said number and therefore the terminal equipment cannot use the packet-based wireless communications network.

### OBJECT AND SUMMARY OF THE INVENTION

It is an object of the invention to provide a method of activating a PDP context via a mobile terminal, initiated by a terminal equipment, where said method does not suffer from the above mentioned drawbacks.

This is achieved when the method described in the opening paragraph is, characterized in comprising the following steps: (a) in the mobile terminal (MT), listening for an activation trigger from the terminal equipment (TE), said activation trigger indicating a request from the terminal equipment (TE) to activate the PDP context; (b) upon detection of an activation trigger from the terminal equipment (TE), in the mobile terminal (MT) deciding, whether to activate a PDP context and, in the affirmative case, which PDP context to activate; and (c) if it was decided to activate a PDP context, transmitting a PDP context activation request message from the mobile terminal (MT) to a support node in the packet-based wireless communications network.

Hereby, the terminal equipment (TE) is able to be connected to the packet-based wireless communications network, e.g. GPRS, UMTS, via the mobile terminal (MT) without any requirement for support for the packet-based wireless communications network in the terminal equipment (TE). The terminal equipment (TE) can thus use standard protocols, i.e. Ethernet (e.g. emulated using Bluetooth PAN profile) and DHCP to connect to the packet-based wireless communications network. Moreover, the terminal equipment can thus be connected to a packet-based wireless communication network, e.g. GPRS, by the intermediate of a packet-oriented connection, which is advantageous in that the GPRS is packet-oriented. Thus, the user friendliness in obtaining such a connection is increased considerably, in that it is not required for the end user of the terminal equipment (TE) to know about any reserved number relating to the APN or the PDP context to activate, any special telephone numbers or data accounts configured in the mobile terminal (MT). In summary, the terminal equipment (TE) can use the packet-based wireless communications network as a network access to e.g. Internet, without any dedicated configuration or software.

Preferably said activation trigger is one of the following: the terminal equipment (TE) creating a connection to the mobile terminal (MT), the terminal equipment (TE) transmitting a DHCP DISCOVER message to the mobile terminal (MT), and the terminal equipment (TE) transmitting a Router Solicitation. The examples of activation triggers above are especially user-friendly in that they require a minimum of user interaction. The connection between the terminal equipment (TE) and the mobile terminal (MT) could preferably be a Bluetooth® BNEP connection; however, other possibilities are conceivable, such as infrared, USB or WLAN.

In a preferred embodiment step (b) of the method of the invention comprises querying for user inputs in regard to the decision of whether to activate a PDP context and/or in regard of which PDP context, if any, to activate. Thus, the mobile terminal (MT) could be configured to suit the needs of an end user. The mobile terminal (MT) could e.g. be configured to automatically activate a default PDP context upon reception of a trigger from a specific terminal equipment (TE), to query a user whether to activate a PDP context or to ignore the trigger from the terminal equipment (TE), or to query the user which PDP context in a list of possible PDP contexts to activate.

In another preferred embodiment of the method according to the invention, step (b) of the method according to the invention comprises deciding to activate a predefined PDP context. This provides an especially fast activation of the PDP context.

Preferably the method according to the invention further comprises the step of: (d) in the mobile terminal (MT), receiving a PDP context activation response message from the support node in the packet-based wireless communications network, and preferably, the method according to the invention is characterized in that the PDP context activation response message comprises configuration parameters for the terminal equipment (TE) to connect to a Packet Data Network (PDN) to which the PDP context is related. Hereby, the necessary steps in an activation of the PDP context can be performed by minimum user interaction.

Preferably the method further comprising the step of: (e) deactivating the PDP context in the mobile terminal (MT) upon reception in the mobile terminal (MT) of a deactivation trigger. Hereby, the PDP context can be deactivated in a user friendly way without much user interaction.

In a preferred embodiment of the method, said deactivation trigger is one of the following: the terminal equipment (TE) terminating the connection to the mobile terminal (MT), the terminal equipment (TE) transmitting a DHCP RELEASE message to the mobile terminal (MT), and expiry of a lease time for said configuration parameters for the connection of said terminal equipment (TE) to said Packet Data Network (PDN).

The invention moreover relates to a mobile terminal providing equivalent advantages as described above.

### BRIEF DESCRIPTION OF THE DRAWINGS

The invention will be explained more fully below in connection with a preferred embodiment and with reference to the drawing, in which:

FIG. 1 is a schematic drawing illustrating a network architecture suitable of implementing the method of the present invention;

FIG. 2a and 2b are flow diagrams of methods according to the invention;

FIG. 3 is a sequence chart showing the communication between the terminal equipment, the mobile terminal and a support node in the PDN according to the invention; and

FIG. 4 is a block diagram showing an example of components of a mobile terminal according to the invention.

### DESCRIPTION OF PREFERRED EMBODIMENTS

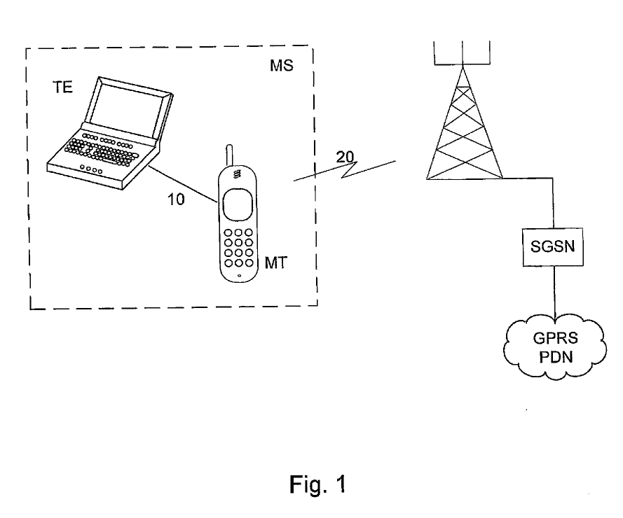

FIG. 1 is a schematic drawing illustrating a network architecture suitable of implementing the method of the present invention. The exemplary architecture illustrated in FIG. 1 is for a GPRS network, although, the invention may be utilized with any type of wireless PDN. In the GPRS network, a mobile station (MS) includes a mobile terminal (MT) which handles the GPRS air interface (20) and a terminal equipment (TE), which is connected to the MT via a PPP connection (10), wired or wireless. On the PDN side of the air interface is a Serving GPRS Support Node (SGSN) and the GPRS PDN.

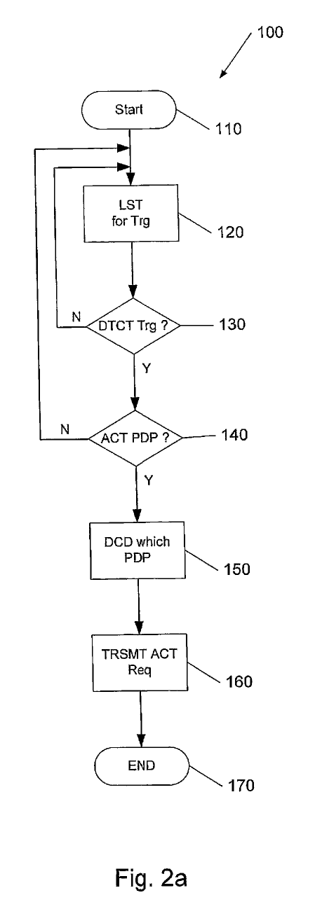

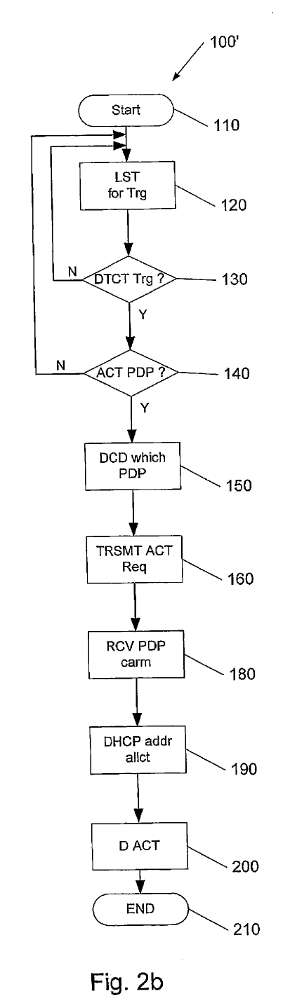

FIG. 2a is a flow diagram of a method 100 according to the invention. The method is performed in a mobile terminal (MT) and the flow starts in step 110. In the subsequent step, step 120, the mobile terminal (MT) is listening for an activation trigger from a terminal equipment (TE). Such an activation trigger could e.g. be:
the terminal equipment (TE) creating a connection to the mobile terminal (MT), e.g. by activating a Bluetooth BNEP connection;
the terminal equipment (TE) transmitting a DHCP DISCOVER message to the mobile terminal (MT), indicating that the terminal equipment (TE) is looking for DHCP servers; or
the terminal equipment (TE) transmitting a Router Solicitation, indicating that the terminal equipment (TE) is looking for routers.

Each of these activation triggers can be interpreted as an indication that the terminal equipment (TE) wants to connect to a network (e.g. the Internet) and needs an IP address and configuration of other IP parameters, such as a default router and DNS (Domain Name Server).

The flow continues in step 120, where it is determined whether an activation trigger has been detected 130. If this is not the case, the flow returns to step 120 for continued listening for an activation trigger. However, if is determined in step 130, that an activation trigger has been detected, the flow continues to step 140, wherein it is decided whether a PDP context is to be activated. It is possible that the user of the mobile terminal (MT) is involved in this decision. For example, the mobile terminal (MT) could query the user whether a PDP context should be activated and/or if the terminal equipment (TE), wherefrom the activation trigger is received, should be ignored. The mobile terminal (MT) could be configured to ignore the activation trigger from the terminal equipment (TE), if the user does not respond to the query/queries above. If the user operating the mobile terminal (MT) indicates that the activation trigger from the terminal equipment (TE) should be ignored, the mobile terminal (MT) could be configured to ignore subsequent activation triggers from the terminal equipment (TE) without querying the user within a predetermined period of time. Finally, the mobile terminal (MT) could be configured to perform a decision in step 140 to activate a PDP context without any user interaction in certain cases, e.g. if the activation trigger is received from one or more specific terminal equipment (TE).

If it was determined in step 140 not to activate a PDP context, the flow returns to step 120. If was determined in step 140 that a PDP context should be activated, the flow continues to step 150, wherein it is decided which PDP context should be activated. Again, the user can be involved in this decision or the decision can be performed automatically within the mobile terminal (MT), i.e. without user interaction. An example of the former instance is that the mobile terminal (MT) queries the user which PDP context out of a list of PDP context relating to different data account in the mobile terminal (MT) that should be activated. An example of the latter instance is that the mobile terminal (MT) can be configured to automatically activate a predefined PDP context upon detection of the activation trigger in step 130 and upon the decision in step 140 for activating a PDP context.

The flow subsequently continues to step 160, wherein a PDP context activation request message is transmitted from the mobile terminal (MT) to a support node (SGSN) in the packet-based wireless communications networks to which the mobile terminal (MT) is arranged to be connected. The flow ends in step 170.

By the method described above, a PDP context can be initiated by a terminal equipment (TE), that is arranged to be connected to the mobile terminal (MT), in a particularly user friendly way, in that it is not required for the user of the terminal equipment (TE) to know and specify any reserved number relating to the PDP context to activate. Moreover, the terminal equipment (TE), that is arranged to be connected to the mobile terminal (MT), is able to connect to the packet-based wireless communications network, e.g. GPRS, UMTS, via the mobile terminal (MT) without any requirement for support for the packet-based wireless communications network in the terminal equipment (TE).

FIG. 2b is a flow diagram of a method 100′ according to the invention. The steps 110 to 160 of the method 100′ are equal to the steps 110 to 160 of the method 100 shown in FIG. 2a, and are therefore not explained again here. In the method 100′ shown in FIG. 2b step 160 is succeed by step 180, wherein the mobile terminal (MT) receives a PDP context activation response message from the SGSN in the GPRS network, to which the PDP context activation request message was transmitted from the mobile terminal (MT). The received PDP context activation response message indicates success or failure to initiate an activation of the PDP context, and in the case of success might also include parameters for configuration, such as an IP address, in order for the terminal equipment (TE) to connect to the packet-based wireless communications network via the mobile terminal (MT).

In the following it is assumed that step 180 was successful, so that a PDP context activation response message was transmitted by the SGSN and received by the mobile terminal (MT). If step 180 was not successful, is could be repeated until a PDP context activation response message is received by the mobile terminal (MT). The subsequent step, step 190, is a DHCP address allocation. The execution of this step depends upon the type of activation trigger and whether the response message from the SGSN included an IP address.

The Trigger was a DHCP DISCOVER Message:

The response message from the SGSN included an IP address:

In the case where the activation trigger was a DHCP DISCOVER MESSAGE and the response message from the SGSN included an IP address, the mobile terminal (MT) subsequently transmits a DHCP OFFER message to the terminal equipment (TE). The DHCP OFFER message includes the IP address and any other parameters included in the SGSN response message. Hereby, the mobile terminal (MT) acts as a DHCP server for the terminal equipment (TE).

The response message from the SGSN did not include an IP address:

In the case where the activation trigger was a DHCP DISCOVER MESSAGE and the response message from the SGSN did not include an IP address, the mobile terminal (MT) relays the DHCP DISCOVER message to the SGSN. When the mobile terminal (MT) subsequently receives a DHCP OFFER message from the SGSN, the mobile terminal (MT) should relay this DHCP OFFER message to the terminal equipment (TE). Thus, the mobile terminal (MT) acts as a DHCP relay for the terminal equipment (TE).

The Trigger was a Creation of a Connection to the Mobile Terminal (MT):

In the following the example of a Bluetooth connection is used. However, the connection created between the terminal equipment (TE) and the mobile terminal (MT) could be any appropriate wired or wireless connection, such as for instance infrared, USB or WLAN. Moreover, it is assumed that the connection between the terminal equipment (TE) and the mobile terminal (MT) is protected by appropriate security, so that only authorized terminal equipments (TE) can connect to the packet based wireless communications network by the intermediate of the mobile terminal (MT)

The response message from the SGSN included an IP address:

In the case where the trigger was an activation of a BNEP connection and the response message from the SGSN included an IP address, the mobile terminal (MT) subsequently stores the IP address and other relevant parameters contained in the response message from the SGSN for use when/if the terminal equipment (TE) subsequently sends a DHCP DISCOVER message. When the mobile terminal (MT) receives such a DHCP DISCOVER message from the terminal equipment (TE), it should respond to the terminal equipment (TE) with a DHCP OFFER response containing the IP address and the other relevant parameters, if any. In this case, the mobile terminal (MT) acts as a DHCP server to the terminal equipment (TE).

The response message from the SGSN did not include an IP address:

In the case where the trigger was an activation of a BNEP connection and the response message from the SGSN did not include an IP address, the mobile terminal (MT) should relay subsequent DHCP DISCOVER messages to the SGSN. When the mobile terminal (MT) subsequently receives a DHCP OFFER message from the SGSN, the mobile terminal (MT) should relay this DHCP OFFER message to the terminal equipment (TE). Thus, the mobile terminal (MT) acts as a DHCP relay for the terminal equipment (TE).

After step 190 as been completed, the terminal equipment (TE) is connected to the packet-based wireless communications network.

The method 100′ continues in step 200, wherein the deactivation of the PDP context takes place. The mobile terminal (MT) should deactivate the PDP context and stop acting as a DHCP server/DHCP relay for the terminal equipment (TE) in any of the following cases:
the terminal equipment (TE) deactivates the connection, e.g. the BNEP connection, to the mobile terminal (MT);
the lease time of the IP address expires, e.g. because the terminal equipment (TE) has not asked for a renewal;
the terminal equipment (TE) transmits a DHCP RELEASE message to the mobile terminal (MT).

The method 100′ ends in step 210.

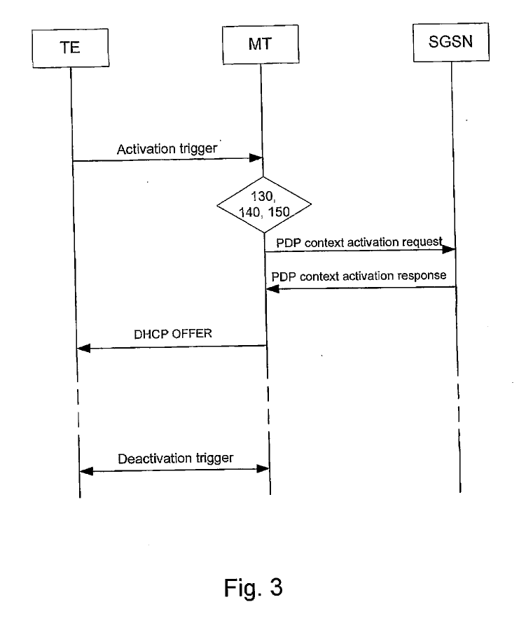

FIG. 3 is a sequence chart showing the communication between the terminal equipment (TE), the mobile terminal (MT) and a support node (SGSN) in the PDN according to the invention. The first part of communication is an activation trigger initiated by the terminal equipment. This activation trigger could, as explained above, be an activation of a BNEP connection between the terminal equipment (TE) and the mobile terminal (MT), a DHCP DISCOVER message sent from the terminal equipment (TE) or a router Solicitation from the terminal equipment (TE). Subsequently, the mobile terminal (MT) performs the steps 130, 140 and 150 of the method 100 or the method 100′, i.e. detects the activation trigger (step 130), decides whether to activate a PDP context (step 140) and decides which PDP context to activate (step 150). Subsequently, the mobile terminal (MT) transmits a PDP context activation request message to the Serving GPRS Support Node (SGSN). As explained above, the SGSN transmits a PDP context activation response message and thereafter the mobile terminal (MT) transmits a DHCP OFFER message to the terminal equipment (TE), irrespective of whether the mobile terminal (MT) acts as a DHCP relay or as a DHCP server for the terminal equipment (TE). Hereafter, the terminal equipment (TE) has is connected to the packet-based wireless communications network via the mobile terminal (MT). This connection can be on-going for virtually any amount of time, which is indicated in FIG. 3 by the broken lines. Finally, the connection of the terminal equipment to the PDP context can be deactivated by means of a deactivation trigger. Such a deactivation trigger could be the terminal equipment (TE) terminating the connection to the mobile terminal (MT), the terminal equipment (TE) transmitting a DHCP RELEASE message to the mobile terminal (MT), and/or expiry of a lease time for said configuration parameters for the connection of said terminal equipment (TE) to said Packet Data Network (PDN).

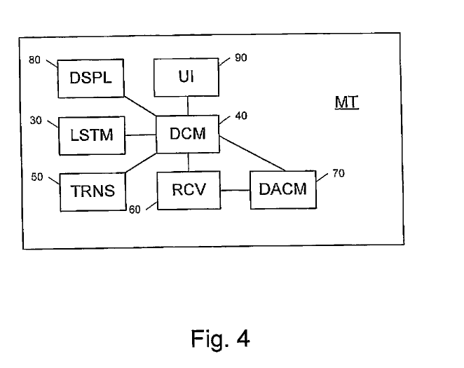

FIG. 4 is a block diagram showing an example of components of a mobile terminal (MT) according to the invention. FIG. 4 shows listening means (LSTM) 30 arranged to listen for an activation trigger from a terminal equipment (not shown), where said activation trigger indicates a request from the terminal equipment to activate a PDP context. The listening means are connected to decision means (DCM) 40 arranged to decide whether to activate a PDP context, and in the affirmative case, which PDP context to activate upon detection of the activation trigger received by the listening means 30 from the terminal equipment. The decision means 40 could e.g. be a microprocessor with a memory. The decision means 40 are further connected to a transmitter 50 arranged to transmit a PDP context activation request message from the mobile terminal to a support node in a packet-based wireless communication network (not shown). Thus, if the decision means 40 decides to activate a PDP context, it sends an order or instruction to the transmitter 50 to transmit the PDP context activation request message. If the transmission was successful a PDP context activation response message sent from the support node in the packet-based wireless communications network can be received by means of a receiver (RCV) 60 in the mobile terminal, which receiver is connected to the decision means 40.

Preferably, the mobile terminal (MT) moreover comprises a display (DSPL) 80 and a user interface (UI) 90, e.g. a keyboard, keypad, a touch sensitive screen, etc., both connected to the decision means, so that the decision means 40 can query a user for inputs, e.g. in regard of a decision of whether to activate a PDP context and/or in regard of which PDP context to activate, if any. Furthermore, the mobile terminal preferably comprises deactivation means 70 connected to the decision means 40 and the receiver 60 and arranged to deactivate the PDP context in the mobile terminal (MT) upon reception in the mobile terminal (MT) of a deactivation trigger. The deactivation trigger could be received by the receiver 60 or be the listening means 30, in dependence of the kind of deactivation trigger.

Even though the components described above are described as separate component, any of the components might be merged together if appropriate. For instance, the transmitter 50 and the receiver 60 could be integrated to one antenna.

It should be noted that as used herein, the term “mobile terminal” is intended to refer to any mobile or portable device comprising communication means, such as mobile telephones, pagers, communicators, i.e. electronic organizers, smartphones or the like. Moreover, it should be emphasised that the term “comprises/comprising” when used in this specification is recorded to specify the presence of stated features, integers, steps or components but does not preclude the presence or addition of one or more other features, integers, steps, components or groups thereof.

1.-16. (canceled)

17. A method of activating a Packet Data Protocol (PDP) context via a mobile terminal, initiated by a terminal equipment arranged to be connected to said mobile terminal, where said mobile terminal is arranged to be connected to a packet-based wireless communications network, comprising the steps of:
listening in the mobile terminal for an activation trigger from the terminal equipment, said activation trigger indicating a request from the terminal equipment to activate the PDP context;
deciding, upon detection of an activation trigger from the terminal equipment in the mobile terminal, whether to activate a PDP context and, in the affirmative case, which PDP context to activate; and
transmitting, if it was decided to activate a PDP context, a PDP context activation request message from the mobile terminal to a support node in the packet-based wireless communications network.

18. The method according to claim 17, wherein the activation trigger further comprises one from the group consisting of:
the terminal equipment creating a connection to the mobile terminal;
the terminal equipment transmitting a Dynamic Host Configuration Protocol (DHCP) DISCOVER message to the mobile terminal; and
the terminal equipment transmitting a Router Solicitation.

19. The method according to claim 17, wherein the deciding whether to activate a PDP context step further comprises querying for user inputs in regard to the decision of whether to activate a PDP context and/or in regard of which PDP context, if any, to activate.

20. The method according to claim 17 wherein the deciding whether to activate a PDP context step further comprises deciding to activate a predefined PDP context.

21. The method according to claim 17, further comprising the step of receiving, in the mobile terminal, a PDP context activation response message from the support node in the packet-based wireless communications network.

22. The method according to claim 21, wherein the PDP context activation response message comprises configuration parameters for the terminal equipment to connect to a Packet Data Network (PDN) to which the PDP context is related.

23. The method according to claim 17, further comprising the step of deactivating the PDP context in the mobile terminal upon reception in the mobile terminal of a deactivation trigger.

24. The method according to claim 23, wherein said deactivation trigger further comprises one from the group consisting of:
the terminal equipment terminating the connection to the mobile terminal;
the terminal equipment transmitting a DHCP RELEASE message to the mobile terminal; and
expiry of a lease time for said configuration parameters for the connection of said terminal equipment to said PDN.

25. A mobile terminal arranged to be coupled to a terminal equipment and arranged to be coupled to a packet-based wireless communications network, said mobile terminal comprising:
a listening means arranged to listen for an activation trigger from the terminal equipment, said activation trigger indicating a request from the terminal equipment to activate the Packet Data Protocol (PDP) context;
a decision means arranged to decide whether to activate a PDP context and, in the affirmative case, which PDP context to activate, upon detection of an activation trigger from the terminal equipment; and
a transmitter arranged to transmit a PDP context activation request message from the mobile terminal to a support node in the packet-based wireless communications network, if it was decided to activate a PDP context.

26. The mobile terminal according to claim 25, wherein said activation trigger is one selected from the group consisting of:
the terminal equipment creating a connection to the mobile terminal;
the terminal equipment transmitting a Dynamic Host Configuration Protocol (DHCP) DISCOVER message to the mobile terminal; and
the terminal equipment transmitting a Router Solicitation.

27. The mobile terminal according to claim 25, wherein the decision means are arranged for querying for user inputs in regard to the decision of whether to activate a PDP context and/or in regard of which PDP context, if any, to activate.

28. The mobile terminal according to claim 25, wherein the decision means are arranged for deciding to activate a predefined PDP context.

29. The mobile terminal according to claim 25, further comprising a receiver arranged to receive a PDP context activation response message from the support node in the packet-based wireless communications network.

30. The mobile terminal according to claim 29, wherein the PDP context activation response message comprises configuration parameters for the terminal equipment to connect to a Packet Data Network (PDN) to which the PDP context is related.

31. The mobile terminal according to claim 25, further comprising a deactivation means arranged to deactivate the PDP context in the mobile terminal upon reception in the mobile terminal of a deactivation trigger.

32. The mobile terminal according to claim 31 wherein said deactivation trigger is one selected from the group consisting of:
the terminal equipment terminating the connection to the mobile terminal;
the terminal equipment transmitting a DHCP RELEASE message to the mobile terminal (MT); and
expiry of a lease time for said configuration parameters for the connection of said terminal equipment to said PDN.
